(19) United States
(12) Patent Application Publication
(10) Pub. No.: US 2020/0120269 A1
(43) Pub. Date: Apr. 16, 2020

(54) DOUBLE-SELFIE SYSTEM FOR PHOTOGRAPHIC DEVICE HAVING AT LEAST TWO CAMERAS

(71) Applicant: Manuchehr Shirmohamadi, Oakland, CA (US)

(72) Inventor: Manuchehr Shirmohamadi, Oakland, CA (US)

(21) Appl. No.: 16/157,112

(22) Filed: Oct. 11, 2018

(51) Int. Cl. H04N 5/232; H04N 5/225; G06F 3/0484; H04N 5/235

(52) U.S. Cl. CPC H04N 5/23229; H04N 5/2353; G06F 3/04845; H04N 5/2258

(57) ABSTRACT

The invention encompasses a device and a system for capturing a photograph created from the combination of two separate views captures substantially simultaneously, wherein a portion of one image is superimposed over a second image, wherein the combined photograph is produced using a single app within a short period of time.

### FIELD OF THE INVENTION

The invention relates to hand-held smartphones with at least two integral cameras, and specifically to an improved system for taking selfies using such devices.

### RELATED APPLICATIONS

None

### BACKGROUND AND PROBLEM STATEMENT

People take photos of themselves alone or together with small groups (“selfies”) with their cell phones, tablets or hand-held computers or other types of electronic/digital camera, and frequently wish to show their location in the background of the picture. However, when taking a selfie, a number of issues are encountered including but not limited to:

(a) Selfies use the secondary (“back”) cameras of cell phones which, for most if not all, are of a much lower quality (lower pixel count) compared to the phones' main (“front”) cameras; hence such selfies are inherently lower quality photos

(b) Due to close proximity of the “self” to the camera in a selfie, the image of the self covers a large portion, sometimes most, of the main image being taken, thereby obscuring the background, which can be undesirable as selfies are frequently meant to convey the person's location or environment, i.e., at a site or interest, a party, with people they know etc.

(c) During taking of the selfie, the user has to balance the image ratio (self vs. background) and the composition between his/her image (self) and the desired background. The ability to do this is limited by arm length and ability to hold the phone by the edges and press the shutter button, leading to a cumbersome and uncomfortable experience and, as we all know, often an unflattering and disappointing outcome (hence the market for the selfie-stick).

When taking pictures in darker areas when flash is needed, a selfie cannot be taken to produce an acceptable image, because the flash source is too close to the subject.

### Current (Prior Art) Technologies

Some phone manufacturers are now making their back camera of higher quality (e.g. new Apple S10). This can reduce the issue with picture quality but is not a good solution overall since image ratio (the self vs. the background) is still limited by distance of camera to subject, limited by arm length.

Some manufacturers (e.g. Nokia) are providing capabilities to take 360 degree pictures thus allowing the self to be in the main picture. However, such photos are usually meant for a different purpose (a 360-degree view) and not well suited for the usual application of selfie, again due to arm length and image ratio and desired composition of the “self” being in the foreground and the background being displayed behind, because a panoramic view is stretched in the horizontal axis and makes the image components both distorted and reduced in size, which may not be desirable for a selfie.

There are apps that allow the user to superimpose the “self” onto the main picture after the main picture is taken (similar to photo-shop or other photo editors). However, this introduces additional tasks/complexities in the selfie process, and the image is not produced “live” (at the moment of or contemporaneously with taking the selfie). The modern world of phone-based photography is very time-limited and people want results immediately, and want to be able to transmit those resulting images to friends without taking time to edit the images.

Various relevant apps are commercially available:

“Superimpose” (by Pankaj Goswami) is an app for layer masking by unmasking, where selected areas of your foreground image become transparent revealing the background image underneath. “CutOut Studio” allows you to cut out the image and remove the background. “Background Eraser HD” allows you to cut out the image and remove the background. “LayerPic” is a simple and easy to make superimposed or juxtaposed photos. “Universal Photo Editor” supports layers, selection, masks and filters.

A relevant (but substantially different) device is the Nokia 8 cell-phone which has a feature called “Dual-Sight” which lets you shoot photos using the front- and rear-facing cameras at the same time. The result is a split-screen view as shown in FIG. 6.

However, the “Dual-Sight” process does not allow manipulation of the images so as to combine or superimpose any part of one image upon the other, and of course is does not address the “selfie” problem of composition.

None of the applications, methods or systems known to the applicant can provide the features or the advantage of the presently claimed invention. There is clearly a need for a device, method and system that allows for improved selfies using a device such as a smartphone or similar.

### BRIEF DESCRIPTION OF THE INVENTION

The invention encompasses a device (a cell phone, tablet, dedicated camera other device with at least two cameras), or a method or a system for capturing a photograph created from the combination of two separate views captures substantially simultaneously, wherein all or a portion of one image is superimposed over a second image, wherein the combined photograph is produced using a single app within 45 seconds.

### BRIEF DESCRIPTION OF THE FIGURES

FIG. 1 shows the cell phone displaying, side-by-side, two images taken simultaneously, the right-hand image is of a happy little girl, and the left had image of a famous and important Federal building which is a legacy to Thomas Jefferson, who founded the US patent system.

FIG. 2 shows one of the images (right hand side) manipulated such that the background is shaded out to emphasize the outline image of the girl in the image; equally the outline could be emphasized by a line, a shadow or a mask. The image of the girl can then be selected and placed on the left-hand side image in front of the building.

FIG. 3 shows the final image on the left-hand side, with the image of the little girl sized and placed in front of the building. These are the essential steps in the selfie process of the disclosed invention. Resizing and positioning can be done manually or automatically.

FIG. 4 shown the front and back images simultaneously as would be presented on the screen, with the images of the two subjects taking the selfie on the right (taken by the lower quality back camera), and the image of the background on the left (taken by the high-quality front camera).

FIG. 5 shows the combined image with the subjects resized and placed in front of the building. Such resizing and positioning can be done manually or automatically.

FIG. 6 Prior Art. discloses the prior art and shows two images displayed on the cell-phone screen for the Nokia 8 “Dual-Sight” feature. The images may not be manipulated or superimposes as in the present invention.

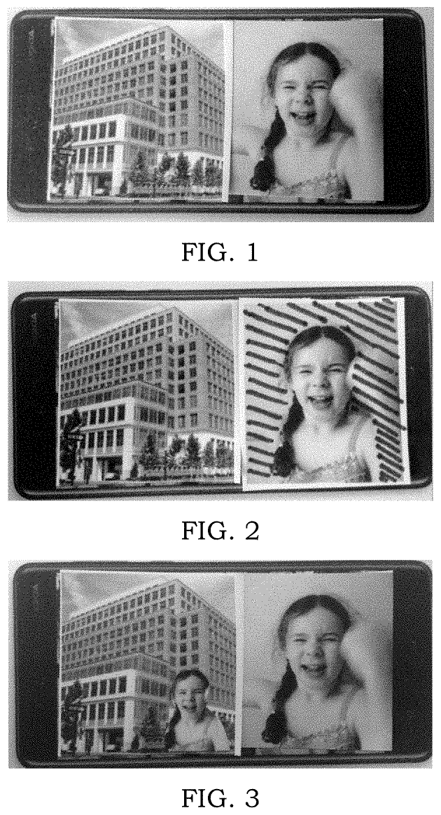

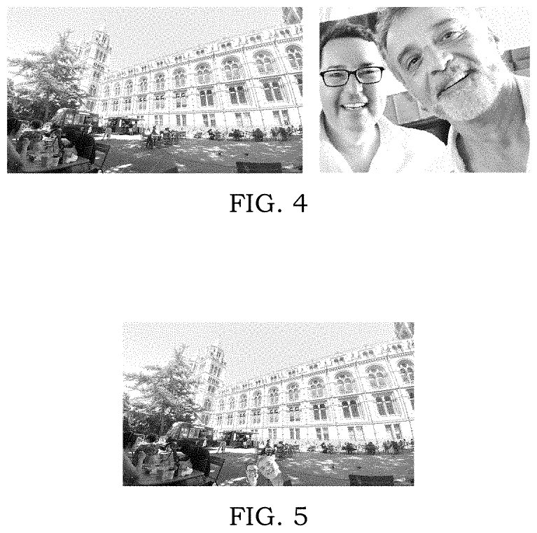

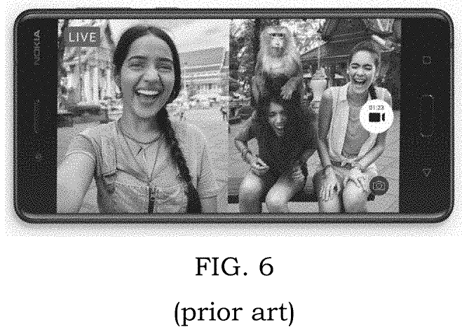

### DETAILED DESCRIPTION OF THE INVENTION

The present invention encompasses a device (a cell phone), method and system that allows for improved selfies using a device such as a smartphone, tablet or similar, by providing simultaneous, real-time viewing through front (high quality) and back (lower quality) cameras, and while viewing, allows simultaneous, real-time display of both front (a ‘first image’, such as distant scenery) and back (a ‘second image’, such as close self-portrait) image on a single camera screen, and allows for real-time manipulation of both images so as to maneuver and arrange the second image (or a part of the second image) into the foreground of, or within or over part of the first image, so as to produce a final image that is a combination of the first and second images; which final image may be immediately or contemporaneously captured and stored.

The present invention also allows the image of the self to be selected and cut from the second image (i.e., removed from the background of the second image) and superimposed upon the first (scenery) image.

The present invention also allows the image of the self to be reduced or enlarged in size to cover a desirable reduced area of the background.

Additionally, the final image can be posted to (shared with) other applications such as social media apps like Instagram, Facebook, etc. and/or be transmitted from the device (smartphone) as part of the actions within the app (by selecting an application via which to send the image), or separately, using a different app, such as WhatsApp or other messaging software.

Both images are displayed simultaneously onto phone's single display, for example under and over or side-by-side. A first image (background) may be displayed in a first panel, and a second image (self) may be displayed in a second panel, both on a single screen. The whole or a portion of the second image may then be positioned over part of the first image.

In certain embodiments, the image of the self(s) (the ‘second image’) of one or more things or people - e.g., just the face, or the face, head and shoulders of one or more people, may be automatically identified by use of image recognition software (e.g., facial recognition), and marked out on the screen and defined by a line surrounding its outline.

In other embodiments, the image of the self(s) may be automatically selected either by a line defining the selected image portion, or by fading or blurring out the background not including the self(s), or by masking the background not including the self(s).

In other embodiments, the background of the second image may become transparent revealing the selected foreground ground image (such as the self(s)) as a clear image. This selected image may then be selected and placed into or over (in the foreground of) the first image (taken by the front camera). In other embodiments, the foreground image may become transparent revealing the background ground image.

In certain embodiments, the software automatically selects a part of the image not by image recognition of a face or person or body part, but by virtue of the selectable part of the image being in the immediate foreground. So, a person taking a selfie will almost certainly have his/her face placed right in front of the (back) camera lens, at a distance of about a meter (an arm's length) from the camera. There will almost certainly be nothing between the back-camera lens and the person's face. The application software can be programed to select and identify only the objects within a set distance from the lens (the face), and to automatically identify and mark out and/or select such an image on the screen.

In any of the cases above, a portion of the second image (the ‘image portion’), usually a face, is selected and marked out on the second image. The selected portion of the second image may then be positioned over the first image. The user may select the marked-out image portion. This may be done by touching or tapping the screen at the appropriate position (on the selected image) and the user may then place the selected image portion from the second image at a location in the first displayed image by tapping the desired location or dragging the image from the panel displaying the second image to/into the panel displaying the first image. This is done at the direction of the user, and the CPU carries out a program that facilitates the movement/placement of the selected portion of the second image so that it is placed within the first image, to create a combined image.

Importantly all these functions and actions (except, optionally, attaching and sending the final image) can be performed in a smooth series of actions while holding the phone, and they do not require closing any apps or programs, or opening any new apps, to manipulate or edit the images. Common methods used for image manipulation on a touch-screen are single or double tapping, two-finger zooming, dragging, etc. For example, the entire process of displaying and viewing both images, (optionally capturing both images), and manipulating the images to superimpose one image onto another image, and then capturing the final image, can be reasonably done within a reasonably short time such as 20 seconds. In other embodiments, the steps from displaying to capturing can be done on the phone within 10 seconds, within 30 seconds or within 45 seconds or within 60 seconds. All (or all except attaching and sending) of these steps can be completed within the given time on the phone without opening a new app or closing the “double-selfie” application.

In a typical embodiment, the invention provides a method/system/cell-phone wherein the following steps may be easily performed by a competent user (one familiar with the system) in a time of no more than 45 seconds, the steps being: (a) activating both first and second cameras so both are active simultaneously, and are able to communicate an electronic first image and an electronic second image to the CPU; (b) displaying the first image and the second image simultaneously but separately on the screen; (c) responding to the activation of a control unit which acts as a shutter release control, such that two images (one from the front and one from the back camera) are substantially simultaneously captured; (d) either automatically or manually selecting and visually delineating at least a portion of the second image; (e) either automatically, or at the direction of the user, facilitating the placement and/or sizing of the selected portion of the second image so that it is placed within the first image, to create a resultant combined image; and (f) facilitating storing the combined image in the memory, thereby creating a photograph created from the combination of two separate views.

In the method of the invention, the action of combining two images can be done before or after image capture. So, in one post-processing embodiment the user may capture the two images and then combine and manipulate them, and then store and send the combined image. In another pre-processing embodiment, the steps of combining and manipulating the images occurs before the images are captured.

Some embodiments of the present invention also provide an image processing means whereby the first and second images are not displayed separately on the screen of the cell-phone, but, when the app is activated, are automatically combined such that a second image or portion of an image (e.g., the self image, from the back camera) is automatically positioned and superimposed on the first image (the background from the front camera). The self image may then be optionally moved, adjusted or manipulated in front of (overlaid with) the background image to the satisfaction of the user, and then captured and stored on the phone.

In another embodiment, the second image or portion of an image (e.g., the self-image) is automatically sized to a proportion of the main image (e.g. 1/16, ⅛, ¼ etc.) and positioned and superimposed on the first image.

Various embodiments of the present invention also provide an image processing means whereby the selected image portion may optionally be manipulated for example to change size or exposure, reduce red-eye etc., using well-known software, methods and systems.

The selected portion may be manipulated either manually or automatically. Manipulation may include changing size, shape, contrast, saturation, exposure, color temperature, and selecting position or orientation. Automatic scaling/resizing may be based on an estimated scale of both images, for example the average face size for the rear camera and average object (e.g., car, tree, building, face etc.) size for the front camera.

Some embodiments of the present invention also provide an image processing means whereby the image of the self can be reduced in size (manually or automatically) to cover a desirable reduced area of the background. The image reduction may be set as a default, between 0% reduction and 90% reduction, and may be set to automatically reduce the size of the selected image, which image is then manually (by dragging or tapping) or automatically superimposed onto the second (background) image.

In one embodiment the invention is a cell-phone or smart-phone having a second camera on a back side adapted to take a second image (the self), and a first camera on a front side adapted to take a first image (the background), and a screen disposed on one side of the cell-phone, and at least one control unit on the cell-phone for controlling functions of the cell-phone, wherein the cell-phone additionally possesses within it a memory, and functionally linked to the memory and to the cameras, a computer processing unit (CPU) programmed to instruct the cell-phone to perform certain steps, including, but not limited to: (a) activating both first and second cameras so both are active simultaneously, and are able to communicate an electronic first image and an electronic second image to the CPU, (b) displaying the first image and the second image simultaneously but separately on the screen, (c) responding to the activation of a control unit which acts as a shutter release control, such that two images (one from the front and one from the back camera) are substantially simultaneously captured, (d) either automatically or manually selecting and visually delineating at least a portion of the second image, (e) either automatically, or at the direction of the user, facilitating the placement and/or sizing of the selected portion of the second image so that it is placed within the first image, to create a combined image, and (f) facilitating storing the combined image in the memory, thereby creating a photograph created from the combination of two separate views.

In some embodiments, the cell-phone camera on the front side has a higher pixel count than the camera on the back side. In other embodiments, it is reversed and in other embodiments both cameras are of the same quality. In still other embodiments only one camera chip is used and light from two separate scenes are projected onto a single chip.

In some embodiments, the cell-phone is programmed such that the portion of the second image, when superimposed on the first image, may be resized and/or placed at a specific location manually by the user.

In some embodiments, the cell-phone is programmed such that the portion of the second image, when superimposed on the first image, is automatically resized and/or placed at a specific location upon the first image, that is to say the software provides instructions to command the image processing system to resize and place the portion of the second image on the first image according to certain pre-programmed parameters.

In some embodiments, the the shutter-release control is placed on the side of the phone and not directly on either of the larger flat front or back surfaces.

In an alternative embodiment, the cell phone has 3 or 4 cameras positioned at different locations, which can all capture an image at the same time, and can use the principles of the invention to combine the 3 or 4 or more images.

In terms of software and programming, this invention encompasses a software application (app) for cell phones (any operating system such as IOS or Android) which have a front and back camera. When activated, both cameras turn on with the front (better) camera showing the main (usually the more distant) image, and the back camera showing the self, or a group of selves (usually closer than the front image). The user sees both images on the display and can manipulate at least one image or part of an image, or both images independently.

In certain embodiments, the app allows the user to modify the image of self ('second image' from back camera) by reducing/enlarging it in size, and can move it over the main image ('first image' from front camera) to his/her desired location. This may be done manually by the user, or in other embodiments the placement, manipulations and/or resizing may be done automatically as programmed into the CPU. This default sizing and placement and manipulation may not be overridden in certain embodiments, or in other embodiments, may be subsequently overridden by the user.

The manipulation may be done either before or after the image is captures. So, a user may view and manipulate the combined image, and when the combined image looks pleasing to the user, he/she can take (capture) the picture (final image). Alternatively, the user may first (temporarily or permanently) capture the combined image, and then manipulate it as desired, and then save and store a final image.

This allows for a much-improved selfie where the user's image is superimposed on the main image (with his/her preference of composition, size and location). This eliminates the problems listed above and allows for much better selfies.

In important embodiments, the cell phone includes a control unit that acts as a shutter-release control, which when depressed instructs the camera (or in the present case, both cameras simultaneously—back and front) to take a picture(s) and capture an image.

In various embodiments, the cell-phone is programmed such that the portion of the second image, when superimposed on the first image, may be resized manually by the user.

In various embodiments, the cell-phone may be programmed such that the portion of the second image, when superimposed on the first image, is automatically resized and/or placed at a specific location upon the first image.

In various embodiments, the cell-phone comprises a shutter-release control which is placed on the side of the phone and not directly on either of the larger flat front or back surfaces.

The invention is highly adaptable to different variations and may be combined with many presently-used methods and techniques for image processing and photo editing. For example, in one embodiment, the application can additionally perform blending of the edges of the self-image to better integrate with and match those of the main image, and so produce a more natural and realistic image. In another example, auto resizing is based on actual image ratios and distances from the camera lens, so that an appropriate scale may be maintained between the self and the background. For example, if the self is 3 meters away, and the background building is 30 meters away, the image ratio would be 10:1. If the desired ration is 20:1 then the size of the self-image can automatically be halved before placement into the background. In yet another embodiment the self-image can be made semi-transparent during positioning over the background image. After positioning the transparency is removed and a normal opaque image appears on the final image.

Although the main examples include a device with two cameras, the invention anticipates devices in which a single camera may be employed, and different parts of the CMOS or CCD chip may be used to capture separate images. In this case, the two apparently separate images displayed will in fact be a single image, relayed from a single chip. The light images impinging in the single chip will be transmitted from two separate lenses, for example (but not exclusively) by use of a fiber-optic lens. Obviously, this embodiment makes manufacturing cheaper.

The proposed invention comprises software (an application (app) for a cell phone, smartphone, tablet or hand-held computer), which software is used to program a computer such that the instructions in the program control various elements of the camera function via a CPU, wherein the functions comprise all of the following means/features: A method/system/means of turning both cameras on simultaneously, with both images displayed simultaneously onto phone's single display, for example under and over or side-by-side. An image processing means/method or system to allow one or both images to be manipulated by the user such as zooming in/out, flash options (for back camera) etc. An image processing means/method or system to allow the user to resize the back camera's image (self). An image processing means/method or system to allow the user to move the back camera's image (self) onto the desired location of the front-camera's image (main view) thus creating a combined image of self and the main images. A system/means to “lock” the combined image into a single final image and capture the picture of the combined image, and store it in the phone's memory. A processing means, method or system to attach the final image and send it via any messaging application. All (or all except attaching and sending) of these steps can be completed within 45 seconds on the phone without opening a new app or closing the “double-selfie” app.

A final and important note about the invention. Clearly the claims to a cell-phone are claims to a mechanical device, used by a person, and not simply to an abstract idea carried out mentally or by a programmed computer. But equally, the claims to a system and to a method require the presence and physical action of a user to point the camera, use human judgement to select the scenes both front and back, and to activate the shutter release, and then in some embodiments to manipulate the images on the screen and make a decision about the final image and to finally save the image. The systems and methods, while they do include certain computer-implemented steps, are not simply to an abstract idea carried out by a computer.

### General Representations Regarding Interpretation of the Invention

In some embodiments, the CPU is running an IOS operating system and in others the CPU is running an Android operating system. This does not exclude all other operating systems.

In this specification, reference is made to particular features of the invention. It is to be understood that the disclosure of the invention in this specification includes all appropriate combinations of such particular features. For example, where a particular feature is disclosed in the context of a particular embodiment or a particular claim, that feature can also be used, to the extent appropriate, in the context of other particular embodiments and claims, and in the invention generally. The embodiments disclosed in this specification are exemplary and do not limit the invention. Other embodiments can be utilized and changes can be made. As used in this specification, the singular forms “a”, “an”, and “the” include plural reference unless the context clearly dictates otherwise. Thus, for example, a reference to “a part” includes a plurality of such parts, and so forth. The term “comprises” and grammatical equivalents thereof are used in this specification to mean that, in addition to the features specifically identified, other features are optionally present. The term “consisting essentially of” and grammatical equivalents thereof is used herein to mean that, in addition to the features specifically identified, other features may be present which do not materially alter the claimed invention. The term “at least” followed by a number is used herein to denote the start of a range beginning with that number (which may be a range having an upper limit or no upper limit, depending on the variable being defined). For example, “at least 1” means 1 or more than 1, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)—(a second number)”, this means a range whose lower limit is the first number and whose upper limit is the second number. Where reference is made in this specification to a method comprising two or more defined steps, the defined steps can be carried out in any order or simultaneously, and the method can optionally include one or more other steps which are carried out before any of the defined steps, between two of the defined steps, or after all the defined steps. Where reference is made herein to “first” and “second” features, this is generally done for identification purposes; unless the context requires otherwise, the first and second features can be the same or different, and reference to a first feature does not mean that a second feature is necessarily present (though it may be present). Where reference is made herein to “a” or “an” feature, this includes the possibility that there are two or more such features (except where the context excludes that possibility).

A simple logic diagram is presented below to exemplify one embodiment. Various steps and elements may be substituted or altered, for example, the moving and manipulation steps may be reversed.

### Definitions

Cell-phone: herein meaning any cordless telephonic communications device communicating over a network; the word “phone” may be equally used. Note that the invention can equally be applied to any form of device such as cell phones, smartphones (any portable phone connectable to the internet using a browser), tablets or any kind or hand-held computers, go-pros, and cameras of any sort including dedicated electronic and digital cameras, so long as the device has a front and a back camera.

Computer processing unit (CPU): a central processing unit is the electronic circuitry within a computer that carries out the instructions of a computer program by performing the basic arithmetic, logical, control and input/output operations specified by the instructions. The word “computer” may equally be used in some contexts.

Control unit: a mechanical and/or electronic interface by which a user can control functions of the cell-phone; for example, a mechanical button, or touch-screen icon, or a means for voice activated control that requires no touching of the control unit, such as a microphone relaying signals to a CPU wherein certain specific command words or sounds are processed and interpreted in the CPU such that a specific action/function of the cell phone is carried out or activated. An important control unit is a shutter-release control that when depressed instructs the camera (or in the present case, both cameras) to take a picture and capture an image.

Camera: Any device adapted to receive a visual image, and in some embodiments, to capture the image into a memory. As used herein the word “camera” may describe a lens coupled with an image sensors such as a CMOS or CCD or other light sensitive array or image sensor or imaging sensor, which is a sensor that detects and conveys the information that constitutes an image. It does so by converting the variable attenuation of light waves into signals, small bursts of current that convey the information. The waves can be light or other electromagnetic radiation. The word camera does not necessarily refer to a system having an image capturing capability or an image storage function.

Image sensor refers to any light or picture capturing sensor such as a CCD or CMOS chip hat receives an image and converts it to a digital signal, typically used in a digital camera. The term “optical input” may be used herein to distinguish an image sensor an input that merely conducts light or an image, such as a fiber optic wire.

Quality: When we talk about the quality of cameras, such as saying that the front camera is high-quality and the rear camera is lower quality, we are not specifying any definitive quality in terms of pixels or resolution or CCD or CMOS density, but simply using a relative term. Indeed, even when specified that one is of higher quality and one lower, it should be understood that both may be of the same or similar quality of that

Image or photograph: A visual depiction that may be stored, including in electronic form, not necessarily viewable by the human eye, but capable of being transformed in such a way so that it can be made visible to the human eye, such as a JPEG, TIF, PNG, or raw file or paper photograph.

Display: sometimes called a “screen”. In this description, the word refers to a physical device or any shape or flexibility adapted to show any forms of image such as an LCD, LED, plasma or CRT screen. The screen on a phone is generally one of LCD (Liquid Crystal Display), IPS-LCD (In-Plane Switching Liquid Crystal Display), OLED (Organic Light-Emitting Diode), or AMOLED (Active-Matrix Organic Light-Emitting Diode).

Capture: Used as the infinitive verb referring to the process of retaining an image, generally in electronic format capable of being stored on a memory such as a JPEG, TIF, PNG, or raw file.

User: A person, emote device, machine or android capable of using and manipulating an image capturing device such as a camera built into a cell phone.

“Selecting and visually identifying”: this phrase refers to identification and demarcation or delineation of a part of an image, such as surrounding the outline of the image position with a line, a haze, a color, a shadow, or highlighting the image portion, or blacking out or greying out the background, so that the image portion may be identified and manipulated.

“Receiving an electronic image”: This phrase describes the passive viewing of any image, such as a camera lens receiving an image projected onto a CMOS or other image processing chip; receiving the image does not necessarily include processing or storage of the image.

“Communicating an electronic image to the CPU”: means sending an electronic coded signal to a CPU wherein the signal is capable of being decoded to produce an image.

System: This refers generally to an entity (an invention) combining necessary structural or means components and method components, wherein the structural components or means are used in the claimed method.

Simultaneous and substantially simultaneous: It should be noted that although the activation of a control unit which acts as a shutter release control should instruct the camera to capture two images (one from the front and one from the back camera) simultaneously, the images may in fact be captured sequentially, but contemporaneously (e.g., within a second of each other. We therefore use the term “substantially simultaneous” when referring to the capture of both images at the same time and when the word ‘simultaneous’ is used it is to inherently be broadened to mean “substantially simultaneous”.

“Back side and front sides” of the cell-phone: These terms are essentially arbitrary designations used to provide a naming convention to distinguish between the two cameras. The back side generally includes the second camera adapted to take an image of the ‘self’, and a front side generally includes a first camera adapted to take an image of the background scene, however the positions may be reversed.

Time to perform actions or steps of a method: In the disclosure, we often refer to actions being performed within a certain maximum time, or in “no more than x seconds”, such as “wherein steps (x) through (y) may be easily performed by a competent user in a time of no more than 45 seconds”. Obviously, this does not limit the time in which the actions may be completed, as a user may perform actions as slowly as he/she wishes, but the phrase refers to the time that a competent user could reasonably and reproducibly perform the actions. This distinguished the invention from separate image processing software that can be used off-line.

1. A system for capturing a photograph created from the combination of two separate views, using device having at least two cameras, wherein the two separate views are displayed on a single screen side by side, separately and simultaneously, the system comprising:
providing a user to take a photograph,
providing a device having a first camera on a front side adapted to take a first image, and a second camera on a back side adapted to take a second image, and a screen disposed on the back side of the device, and at least one control unit on the device for controlling functions of the device,
wherein the device additionally possesses within it a memory, and functionally linked to the memory and to the cameras, a computer processing unit (CPU) programmed to instruct the device to perform the following steps:
(a) activating both first and second cameras so both are active simultaneously, and are able to communicate an electronic first image and an electronic second image to the CPU,
(b) displaying the first image and the second image side by side, simultaneously but separately on the screen,
(c) manually selecting and visually delineating at least a portion of the second image, wherein said visually delineating is achieved by demarking the selected portion of the second image with a visible line, or by fading or masking the background.
(d) at the direction of the user, facilitating the movement and placement of the selected portion of the second image so that it is placed within the first image, to create a combined image,
(e) facilitating storing the combined image in the memory, thereby creating a photograph created from the combination of two separate views; and
(g) storing the combined image in a memory, wherein steps (a) through (g) may be easily performed by a competent user in a time of no more than 60 seconds.

2. The system of claim 1 wherein the camera on the back side has a lower pixel count than the camera on the front side.

3. (canceled)

4. The system of claim 1 wherein at step (d) the user may additionally manipulate the size of the selected portion of the second image.

5. The system of claim 1 wherein at step (d) the movement and/or placement of the selected portion of the second image is achieved by dragging the selected portion from a first location to a second location.

6. The system of claim 1 wherein at step (d) the movement and/or placement of the selected portion of the second image is achieved by tapping on the selected portion to cut or copy it, and then tapping on the destination location to paste it.

7. A system for capturing a photograph created from the combination of two separate views, using a cell-phone having at least two cameras, the system comprising:
providing a user to take a photograph using the cell-phone,
providing a cell-phone having a first camera on a front side adapted to take a first image, and a second camera on a back side adapted to take a second image, and a screen disposed upon one side of the cell-phone, and at least one control unit on the cell-phone for controlling functions of the cell-phone,
wherein the cell-phone additionally possesses within it a memory, and functionally linked to the memory and to the cameras, a computer processing unit (CPU) programmed to instruct the cell-phone to perform the following steps:
(a) activating both first and second cameras so both are active simultaneously, and are able to receive an electronic first image and an electronic second image and communicate the images to the CPU,
(b) automatically selecting at least a portion of the second image, and automatically combining said portion of the second image with at least a portion of the first image to produce a combined image,
(c) displaying the combined image on the screen,
(d) facilitating storing the combined image in the memory, thereby creating a photograph created from the combination of two separate views.

8. The system of claim 7 wherein the camera on the front side has a higher pixel count than the camera on the back side.

9. The system of claim 7 wherein at step (c) the combined image displayed on the screen shows the portion of the second image superimposed on the first image.

10. The system of claim 9 wherein the portion of the second image, when superimposed on the first image, is clearly displayed as being delineated from the first image, and may be manipulated and/or placed in a particular location as desired upon the first image, manually by the user.

11. The system of claim 10 wherein the portion of the second image, when superimposed on the first image, may be resized manually by the user.

12. The system of claim 9 wherein the portion of the second image superimposed on the first image is automatically manipulated and placed in a particular location upon the first image.

13. The system of claim 12 wherein the portion of the second image, having been automatically manipulated and placed in a particular location upon the first image, may subsequently be resized or moved within the first image.

14. The system of claim 1 wherein the device is a cell-phone or smart-phone.

15. The system of claim 1 wherein the device is a tablet computer.

16. The system of claim 1 wherein the device is a hand-held computer.

17. The system of claim 1 wherein the device is a camera or other digital photographic device.

18. A cell-phone having a first camera on a front side adapted to take a first image, and a second camera on a back side adapted to take a second image, and a screen disposed on one side of the cell-phone, and at least one control unit on the cell-phone for controlling functions of the cell-phone, wherein the cell-phone additionally possesses a memory module, and a computer processing unit (CPU) functionally linked to the memory and to the cameras, wherein the CPU is programmed to instruct the cell-phone to perform the following functions/steps:
(a) activating both first and second cameras so both are active simultaneously, and are able to communicate an electronic first image and an electronic second image to the CPU,
(b) displaying the first image and the second image simultaneously but separately on the screen,
(c) responding to the activation of the control unit which acts as a shutter release control, such that two images (one from the front and one from the back camera) are substantially simultaneously captured,
(d) either automatically or manually selecting and optionally visually delineating at least a portion of the second image,
(e) either automatically, or at the direction of the user, facilitating the placement and/or sizing of the selected portion of the second image so that it is placed within the first image, to create a combined image,
(f) facilitating storing the combined image in the memory, thereby creating a photograph created from the combination of two separate views.

19. The cell-phone of claim 18 wherein the camera on the front side has a higher pixel count than the camera on the back side.

20. The cell-phone of claim 18, programmed such that the portion of the second image, when superimposed on the first image, may be resized and/or placed at a specific location manually by the user.

21. The cell-phone of claim 18, programmed such that the portion of the second image, when superimposed on the first image, is automatically resized and/or placed at a specific location upon the first image.

22. The cell-phone of claim 18 wherein the shutter-release control is placed on the side of the phone and not directly on either of the larger flat front or back surfaces.

23. The cell phone of claim 18 having three or more cameras and capturing and combining at least three images.

24. The cell phone of claim 18 wherein the CPU is additionally programmed to perform the function of blurring or bleeding the edges of the selected portion of the second image to better integrate with the first image on which it is being placed.

25. The cell phone of claim 18 wherein the sizing of the selected portion of the second image in step (e) is performed based on distance of images from cameras, and desired pre-set image ratios so that an appropriate scale may be maintained.

26. The cell phone of claim 18 wherein the selected portion of the second image may be made semi-transparent during step (e) to facilitate the placement of the selected portion of the second image within the first image.

27. The cell phone of claim 18 wherein steps (a) through (f) may be easily performed by a competent user in a time of no more than 45 seconds.

28. A method for capturing a photograph created from the combination of two separate views, using device having at least two image inputs, the method comprising the steps of (a) providing a user to control a device, and (b) providing a device for capturing digital images, wherein the device has at least two image inputs, and: (c) capturing first image and the second image simultaneously and communicating them to a CPU within the device, (d) displaying the first image and the second image simultaneously but separately on a screen integrated into the device, (e) selecting at least a portion of the second image, (f) placing the selected portion of the second image within the first image, to create a combined image, and (g) storing the combined image in a memory, wherein steps (c) through (g) may be easily performed by a competent user in a time of no more than 45 seconds.

29. The method of claim 28 wherein the two image inputs are provided by two separate cameras.

30. The method of claim 28 wherein the two image inputs are optical inputs that communicate separate images to a single image sensor chip.
